(19) United States
(12) Patent Application Publication
(10) Pub. No.: US 2003/0028494 A1
(43) Pub. Date: Feb. 6, 2003

(54) Electronic document management system and method

(76) Inventors: Shawn L. King, Kanata (CA); John Desrochers, Kanata (CA)

Correspondence Address: Wm. A. VanSanten, WOOD, PHILLIPS, VAN SANTEN, CLARK & MORTIMER, Suite 3800, 500 West Madison Street, Chicago, IL, 60661, US

(21) Appl. No.: 09/923,615

(22) Filed: Aug. 6, 2001

(51) Int. Cl. G06F 17/60

(52) U.S. Cl. 705/71

(57) ABSTRACT

The invention provides a system and method for establishing and managing authenticated electronic documents (e.g. commercial contracts) whereby the content, revision status and authenticating parties are stored, tracked, retrieved and validated on demand by permitted users. Variable document data is input by user into an electronic form template and this data is captured by the system. The system derives a document number and revision number for the document and all of this identifying information is associated with the document and stored. A document digest formula is applied to generate a unique document digest. The system then generates a unique barcode for each page of the document based on the digest, document number, revision number and paging details and the barcodes are electronically added to the associated pages of the document. Either the parties to the document sign a printed copy of the barcoded document or a digital signature is applied using a third party validation service. The resultant signed and barcoded document is stored electronically whereby permitted users may locate existing documents (e.g. contracts), track document revisions and validate document contents and signatories.

### FIELD OF THE INVENTION

This invention relates generally to the field of electronic commerce (“e-commerce”) software applications and, more particularly, to an electronic system and method for creating, managing and authenticating documents, such as commercial contracts, in electronic form.

### BACKGROUND OF THE INVENTION

Cryptography is frequently employed within networked systems as a security measure and uses private and public keys. The terms “private key” and “public key” are well known terms of art and are used for asymmetric cryptography in which one key is used for encryption and the other for decryption and one of these keys, namely the private key, is kept by the user and never revealed or transferred. Asymmetric cryptography is considered to provide a higher level of security than symmetric cryptography for which a shared key is used for both encryption and decryption (the sharing aspect introducing an element of insecurity). When using asymmetric cryptography to send a message to another party, the public key of that party is located by means of a public key infrastructure (PKI) and is used to encrypt the message; then, only the person with the corresponding private key (i.e. being the other party for whom the message is created) is able to decrypt the message.

The term digital signature is also a well known term of art and refers to a message digest encrypted using a private key, a message digest being a condensed form of a document or transaction to be signed which cannot be used to recreate the document or transaction itself, and which is extremely sensitive to small changes in the document. The digital signature is verified by decrypting it with the corresponding public key to recover the message digest and then comparing the recovered message digest with one computed by a verifier using the document which was purported to be signed. Although encrypted message digests may be used to verify that a party holds a specific private key they are more commonly used to prove that the holder of a specific key was involved in a transaction involving the message; for example, to identify that they gave their assent to the message, just as a physical signature is used to indicate the participation of the signing party in a document. In this case, the encrypted form of the digest must be retained at a secure site.

One of the problematic aspects of e-commerce is the necessity to verify both the parties and the contents of any given transaction (e.g. contract). The foregoing electronic security technologies are available to authenticate the parties participating in a transaction (i.e. electronic signatures, digital certificates and third party authentication) but these technologies are insufficient to also enable a user to validate the exact content of a document signed by the parties thereto. This is a substantial concern associated with e-commerce given the ease with which the data that makes up an electronic contract can become corrupt and thereby make the enforcement of these kinds of contracts very difficult.

There is a need, therefore, for a more effective and flexible means for validating the verity of an electronically generated and authenticated document such as a commercial contract, whereby both the contents and signatures may be matched to one another. Further is a need for a means to readily identify and track the changes made to such an electronic document during its lifecycle.

### SUMMARY OF THE INVENTION

In accordance with the invention there is provided an electronic system and method for creating, managing and authenticating documents (e.g. commercial contracts) whereby the content, revision status and authenticating parties are stored, tracked, retrieved and validated on demand by permitted users.

In accordance with the invention there are provided an electronic document management system and method for verifying the contents of an electronic document exchanged through a network and comprising variable data input by a user. Data defining an electronic document is captured and stored by the system, the captured data including at least the variable data. The variable data is input by a user and captured into a pre-determined electronic form template whereby the data defining the electronic document comprises the variable data and the pre-determined electronic form template. A unique document number and revision number are generated for the defined electronic document and stored with the captured data. A unique digest is generated from the defined electronic document by applying a secure algorithm thereto whereby the digest is uniquely associated with the defined electronic document. The unique digest is stored and associated with the defined electronic document. A barcode is generated for each page of the defined electronic document from the unique digest, the document number and its revision number, and paging details, whereby the barcode uniquely identifies the page of the defined electronic document to which it pertains and the contents thereof. The defined electronic document with the barcode added thereto is forwarded for use by a user. The barcoded defined electronic document forwarded for use by a user may be in the form of an electronic image such as a PDF formatted image.

For processing digitally-signed documents a unique digital exchange key is generated by applying the secure algorithm to the electronic image and stored in association with the defined electronic document.

In use, the barcoded document is authenticated by the parties either by hand-signing a printed copy of the barcoded document or by applying a digital signature using a third party validation service. The resultant barcoded, signed and authenticated document is associated to the variable data originally input by the user by cross-referencing the digest component of that barcode to the stored digest associated with the defined electronic document. Upon successful association the system binds the signed document (an electronic image) to the original input data. The electronic storage of the resulting bound documents permits authorized users to locate existing documents (e.g. contracts), track document revisions and validate document contents and signatories.

### DESCRIPTION OF THE DRAWINGS

The present invention is described in detail below with reference to the following drawings in which like reference numerals refer throughout to like elements.

FIG. 1 is an operational block diagram showing the hardware components of, and steps performed by, a preferred implementation of an electronic document management system in accordance with the invention;

FIG. 2 is a sample barcoded contract established by the electronic document management system of FIG. 1;

FIG. 3 is a flow chart showing the steps of a method for creating and storing a barcoded document in accordance with the invention;

FIG. 4 is a flow chart showing the steps of a method for receiving and storing a hand-signed barcoded document in accordance with the invention; and,

FIGS. 5(a) and 5(b) are a flow chart showing the steps of a method for receiving and storing a digitally signed barcoded document in accordance with the invention (the flow chart of FIG. 5(b) continuing from that of FIG. 5(a)).

### DETAILED DESCRIPTION OF A PREFERRED EMBODIMENT

The present invention is an electronic document management system which, in the preferred embodiment described herein, is implemented in software components. FIG. 1 shows hardware components which are used to implement a preferred embodiment of the electronic document management system. The components of the illustrated system are shown in the top portion “A” of FIG. 1 and the alternative and/or complementary user components, comprising a web-enabled cell phone/personal digital assistant (PDA) 20, PC 30, printer 40 and/or fax machine 50, are shown in the bottom portion “B” of FIG. 1.

The electronic document management system operates on hardware which includes a secure Authentication server 25 for communicating in a secure manner with a Web/Application server 45 to validate users of the system. A Web/Application server 45 interfaces to the user's web-enabled cell phone and PC components 20, 30 for data transfer therebetween and also communicates with a secure Database 35 to create and manage electronic documents. A Receipt/Delivery server 55 receives documents from the Web/Application server 45 and interfaces to the user components PC 30, printer 40 and fax 50 to email, print or fax documents, respectively. The Receipt/Delivery server 55 also receives authenticated (i.e. signed) faxed documents from the user via the fax machine 50. The Receipt/Delivery server 55 communicates with the Database 35 to validate and store signed documents. The functionality and components of the Authentication, Web/Application, Database and Receipt/Delivery servers 25, 45, 35, 55 of this preferred embodiment are detailed below. However, it is to be understood by the reader that the software components of the electronic document management system may be implemented by means of different software/hardware configurations and components for alternative embodiments.

The Web/Application server 45 provides two functions, namely, a Web server function and an Application server function. The Web server function runs applications for displaying system screens and documents to the user in a user-requested format (HTML, WML, PDF, etc.). The Application server function runs components of the electronic document management system including a document forwarding component which forwards documents for faxing, emailing and printing by the Receipt/Delivery server 55. It also receives input from the Web server, validates user inputs and stores those inputs in the Database 35. Hardware and software components used for the Web/Application server 45 in the preferred embodiment are the following:

System: Redhat Linux 7 [other options: Windows NT, or Solaris 7]

Processor: Pentium III 1000 MHz [other options: UltraSPARC]

Memory: 512 MB (or more)

Disk: redundant 9 GB (or more)

Application Software:

Web Server: Apache 1.3 with SSL supporting high security connections.

JSP/Servlet Server: Tomcat 3

Development Software:

Java 1.3

Java Database Connectivity (JDBC) 2.0

Java Server Pages (JSP) 1.1

Java Servlets 2.2

Apache Batik 1.0, FOP 0.19, Xalan 2.0.0, Xerces 1.2.3

The Database (with an associated server) 35 provides storage for storing user inputs and document identification data including digests and signed electronic documents (i.e. images). The hardware and software components used for the Database (and server) 35 in the preferred embodiment are the following:

System: Redhat Linux 7 [other options: Windows NT, or Solaris 7]

Processor: Pentium III 1000 MHz [other options: UltraSPARC]

Memory: 1024 MB (or more)

Disk: array of suitable size for storage needs

Database: Oracle 8i RDBMS [other options: DB2, or SQL Server]

The Authentication server 25 performs user account maintenance functions. These functions include user and password authentication, account expiry, maintenance of user attributes, account locking and account disabling. The hardware and software components used for the Authentication server 25 in the preferred embodiment are the following:

System: Redhat Linux 7 [other options: Windows NT, or Solaris 7]

Processor: Pentium III 1000 MHz (or more) [other options: UltraSPARC]

Memory: 512 MB (or more)

LDAP application software iPlanet [other options: Open LDAP or Oracle]

The Receipt/Delivery server 55 receives documents from the Application server 45 and emails, prints or faxes them to a specified destination. The Receipt/Delivery server 55 also receives faxed or emailed signed documents by means of a document receiving component and interacts with the Database 35 for storage. The hardware and software components used for the Receipt/Delivery server 55 in the preferred embodiment are the following:

System: Redhat Linux 7 [other options: Windows NT, or Solaris 7]

Processor: Pentium III 1000 MHz [other options: UltraSPARC]

Memory: 512 MB (or more)

Fax Application software: Efax [or Hylafax]

Print Application software: LPRng

Email Application software: Sendmail 8, Imapd, and JavaMail 1.2

FIG. 2 represents a sample document, being a commercial contract in this illustration, created by the subject electronic document management system.

Variable data is input by the user (via cell phone/PDA 20 or PC 30), and captured by a data capturing component of the system using a predetermined electronic template such that the variable data, in the context of that particular template, defines an electronic document. A form-type document template is contemplated for use by the preferred embodiment described herein but any type of template may be used, as desired, for a particular application and does not restrict, or form part of, the electronic document management system claimed herein.

A representation of the variable input data, system-assigned document and revision numbers and fixed document template data is copied by the Application server 45 into an array of bytes to which NIST's secure hash algorithm is applied by a document digest generator component to generate a unique document digest. A Java security object (employing the Java software products of Sun Microsystems, Inc. of California, U.S.A.) is used to implement NIST's secure hash algorithm known as SHA. This algorithm is well known by persons skilled in the art and it is broadly published and available to the public, for example, see FIPS PUB 180-1, Federal Information Processing Standards Publication, Secure Hash Standards, issued Apr. 17, 1995 by the U.S. Department of Commerce. The document number, revision number and paging details for that document are combined with the generated unique digest to produce a document identifier which is uniquely associated with a specific page of that specific document. This unique document identifier is then converted to a 2 OF 5 Interleaved formatted barcode 100 (see FIG. 2) using a barcode generator component and inserted into the associated page of the document (see the barcode 100 applied to the document of FIG. 2).

Advantageously, the generated barcode is unique to the specific contents of the associated document page and, as such, any change made to the contents of that page may be identified and tracked by reference to this barcode and any subsequent barcodes derived for revisions of the document.

A signature is applied to the document using one of the following alternative methods:

1. The document may be printed by a user via printer 40, hand-signed by all parties, and then faxed via fax machine 50 to the Receipt/Delivery server 55 (in this case it is assumed that the hand-signing of the document is locally validated e.g. the party faxing back the signed document may be a representative of the contracting authority, such as a sales person, and may be assumed to have validated, by witnessing, the signing of the document of the other party who may be a customer); or,

2. Digital signatures may be applied to the document using third party validation services and then forwarded to the Receipt/Delivery server 55.

The Receipt/Delivery server 55 receives a signed document and for each page uses a barcode verification component to identify and validate the barcode therein, comparing the digest of the received document with that of the document data associated with the defined (i.e. original) document. Once the document has been validated the Receipt/Delivery server 55 stores it within Database 35.

To validate that the contents of a received document are identical to the original document, the barcode is parsed to determine the document number, revision number, paging details and digest. The document number is used to retrieve the defined document from the Database 35. The digest for the defined document is compared to the digest of the barcode of the received document. Any difference between the new digest value and the stored digest value for the defined document results in a determination that the received document is invalid. The received document is then placed in a rejection queue for manual intervention.

The flowchart of FIG. 3 shows a preferred sequence of steps performed by the system to create and store a barcoded electronic document in accordance with the invention. An authorized user enters variable data into a predetermined electronic form template. The user-input variable data is validated and the document is stored in the Database 35 together with a system-generated unique document number and revision number for that document. A document digest is generated as described above and the resulting digest is associated with the document and stored in the Database 35. A document image generator component of the system then generates an image of the document, this being a PDF image in the illustrated example. A unique barcode, comprising the document and revision numbers, document digest and paging details, is generated and attached to each page of the document image. For use in validating digitally signed documents, a digital exchange key generator component generates a digital exchange key by applying the same hash algorithm to the entire document image (i.e. the entire PDF file in this example) and this digital exchange key is stored in Database 35. The document image is then forwarded for delivery to a user's fax, printer or email address.

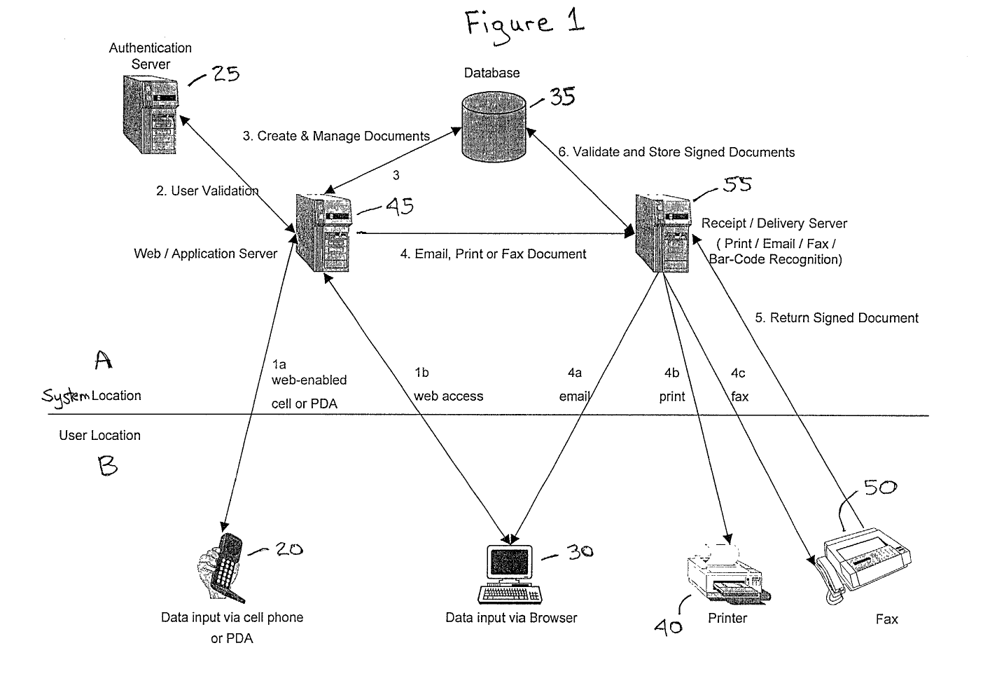

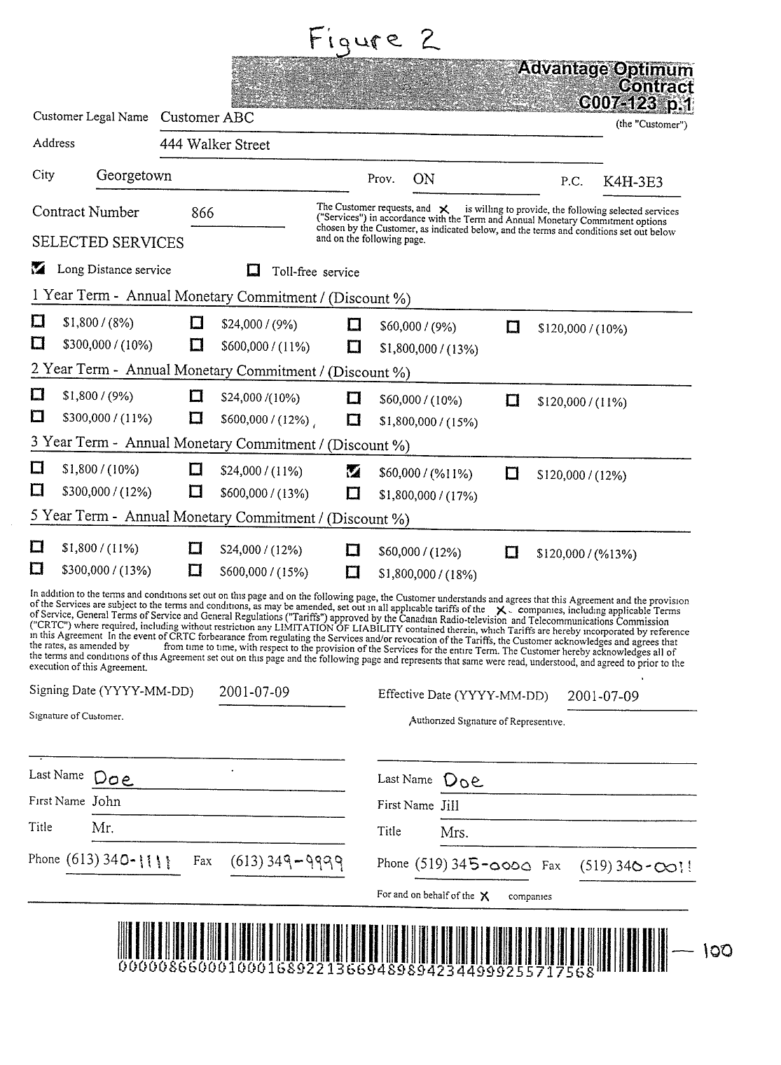

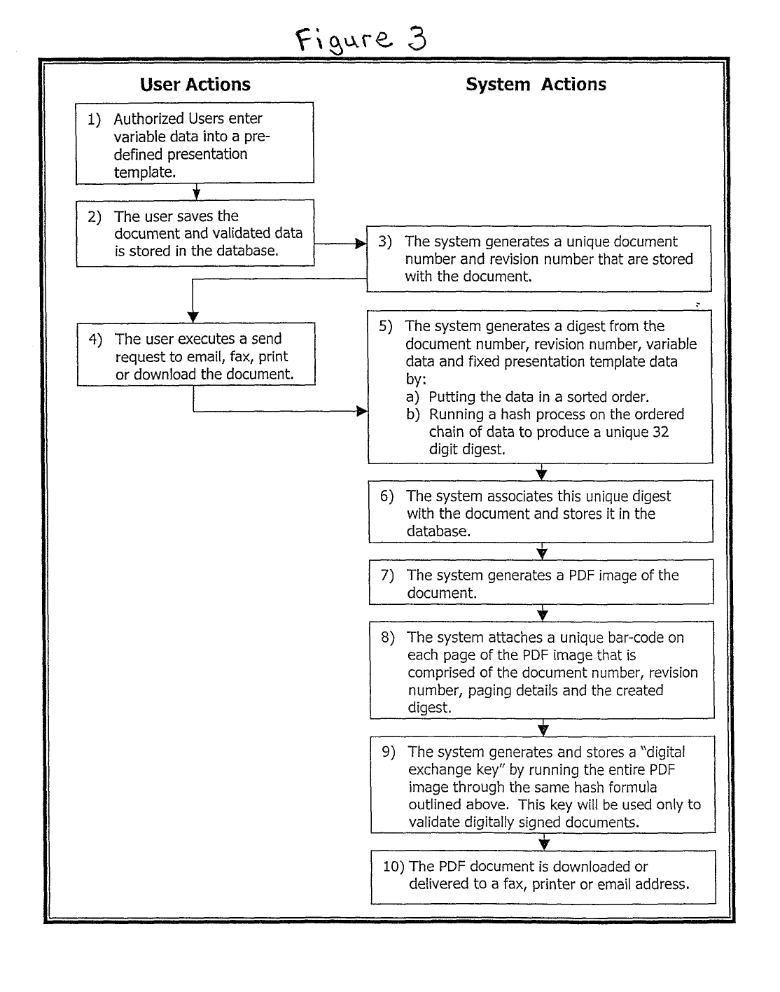

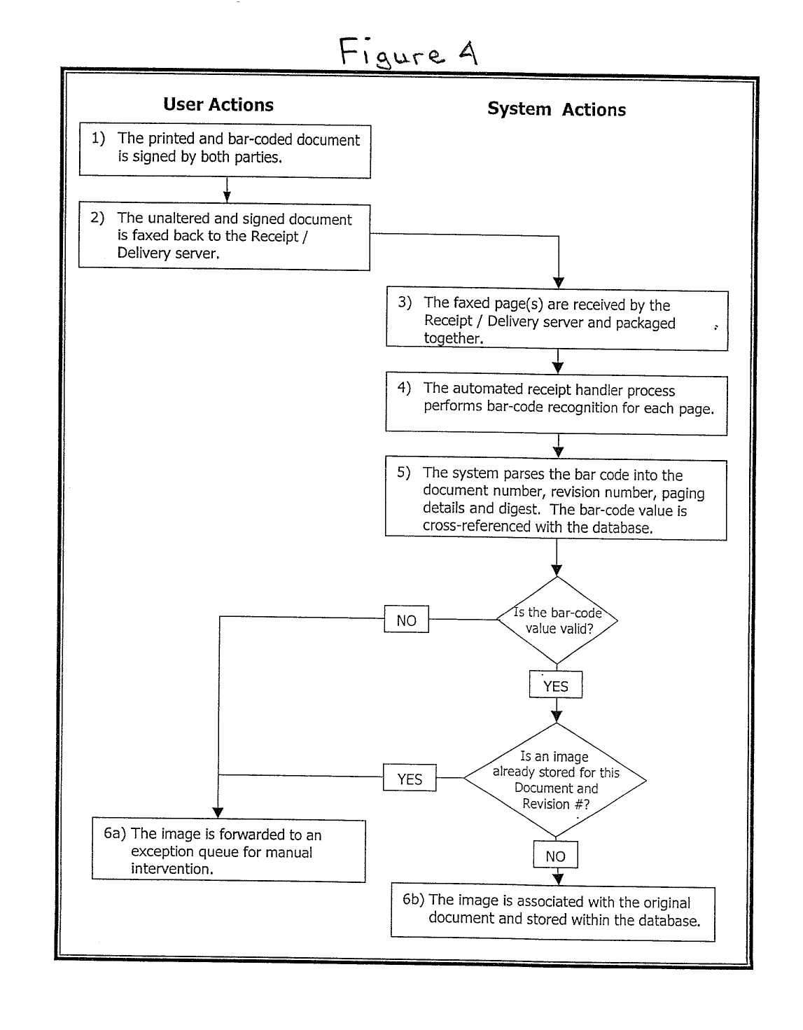

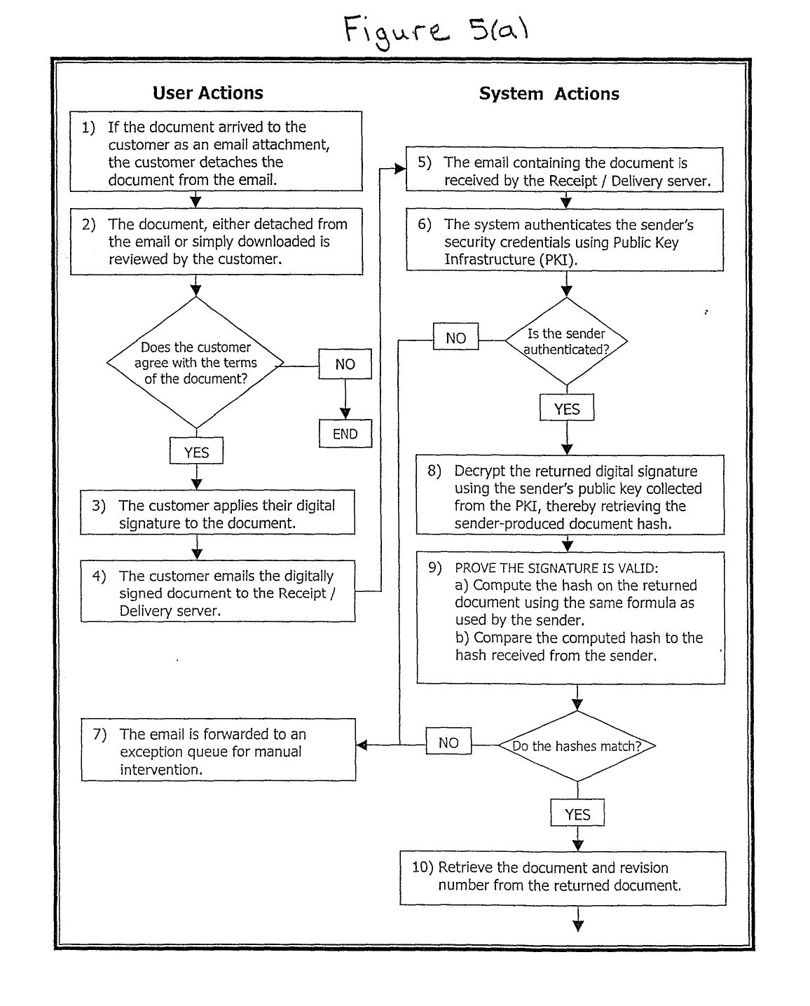

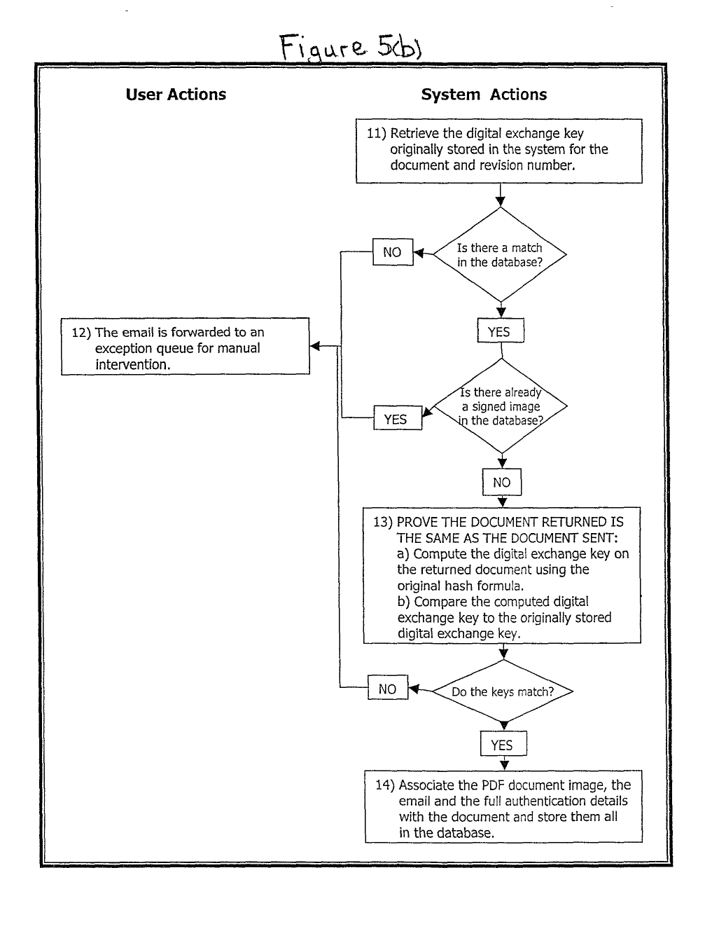

The flowcharts of FIGS. 4 and 5(a),(b) show preferred sequences of steps performed by the system to receive and store hand-signed and digitally-signed barcoded documents, respectively. As detailed by FIG. 4, for a hand-signed document it is faxed to the Receipt/Delivery server 55 and that server scans the barcode from each page of the electronic copy of the faxed-in document. If the barcodes cannot be located on the pages or the barcodes of each page of the document do not conform (apart from the page number) then the electronic copy of the faxed-in document is forwarded to a local exception queue for manual intervention. The scanned barcodes are parsed into their components: document number, revision number, paging details, and digest; and these components are cross-referenced to those stored in the Database server 35 for the defined document. If the values do not match any stored value, or if there is already an image of a signed document stored for the document values, the electronic copy of the faxed-in document is forwarded to an exception queue for manual intervention. If an image has not yet been stored, the image of the signed document is associated with the original stored document and stored in the Database 35.

As detailed by FIGS. 5(a) and (b), for a digitally-signed document the user applies their digital signature to the document if they agree to the terms of the document and the digitally signed document is then emailed to the Receipt/Delivery server 55 where the user's security credentials are authenticated by a digital signature authentication component using the Public Key Infrastructure (PKI). If the user is authenticated the digital signature authentication component decrypts the digital signature using the user's public key collected from the PKI and thereby retrieves the document hash as computed by the user. The digital signature authentication component then verifies the validity of the signature by applying to the received document the same hash formula used by the user and the resulting hash value is compared to the hash value retrieved from the digital signature received from the user (it is to be noted that this hash formula is applied for purposes of the selected cryptographic processes for applying the digital signature and it is not the same hash formula applied by the system to produce the document digest). If the hash values do not match, the verification process has failed and the email is forwarded to another mailbox for manual intervention. If they do match, the document and revision numbers are retrieved from the received document and, using this information, a digital exchange key verification component retrieves from the Database 35 the stored digital exchange key which is associated with those document and revision numbers. If an associated digital exchange key cannot be located, or if an existing signed image is already stored, then the verification process has failed and the email is forwarded to another mailbox for manual intervention. If an associated digital exchange key is located and no existing signed image exists, the digital exchange key verification component takes steps to prove the returned document is the same as the sent document. To do so, it computes the digital exchange key for the received document using the original hash formula and the computed digital exchange key is compared to the stored digital exchange key for the defined (i.e. original) document. If the keys do not match the verification process has failed and the email is forwarded to another mailbox for manual intervention. If the keys match the document image, the email and the full authentication details are associated with the defined document and all of these are stored in the Database 35.

It will be appreciated by the reader that the foregoing electronic document management system and method provide effective means for closely and accurately tracking the contents of electronic documents exchanged between parties over a network and for verifying the validity of the contents of each page of an electronic document that has been hand-signed or digitally signed by one or more parties.

While the invention has been described herein with reference to a system and method for creating, managing and authenticating commercial contracts it will be apparent to the reader that the invention may be applied to any type of document which is subject to embodiment in an electronic format. Similarly, while it is preferable to interface the system to the user through a cellular telecommunications network and/or an Internet global communication network, to take advantage of the broad availability and accessibility of this network to users, the invention is not limited thereto and an intranet could instead be used. Further, it is to be understood that the specific system components described herein may be embodied in and implemented by any number of alternative discrete hardware components, as appropriate, and the embodiment described here is not intended to limit the scope of the invention which is defined solely by the appended claims. From the teachings provided herein, a person skilled in the art is able to implement the invention by means of alternative computer program embodiments.

What is claimed is:

1. An electronic document management system for verifying the contents of an electronic document exchanged through a network and comprising variable data input by a user, said system comprising:
(a) a data capturing component for capturing data defining an electronic document, wherein said data comprises at least said variable data, and forwarding said data for storage;
(b) a document digest generator for generating a digest from said defined electronic document by applying a secure algorithm thereto, whereby said digest is uniquely associated with said defined electronic document, and forwarding said digest for storage in association with said defined electronic document;
(c) a barcode generator for generating a barcode from said generated digest whereby said barcode uniquely identifies said defined electronic document and the contents thereof;
(d) a document forwarding component for forwarding said defined electronic document with said barcode added thereto for use by a user;
(e) a document receiving component for receiving from a user a signed electronic document comprising variable data and a barcode; and,
(f) a barcode verification component for determining the validity of said barcode of said received electronic document wherein a digest component of said barcode is compared to said stored digest associated with said defined electronic document.

2. An electronic document management system according to claim 1 wherein a unique document number is generated for said defined electronic document, said document number is stored with said captured data and said digest is generated from said defined electronic document and said document number.

3. An electronic document management system according to claim 2 wherein said user inputs said variable data into a pre-determined electronic form template and said data defining said electronic document comprises said variable data and said predetermined electronic form template.

4. An electronic document management system according to claim 3 wherein a unique document revision number is generated for said defined electronic document, said document revision number is stored with said captured data and said digest is generated from said defined electronic document and said document and revision numbers.

5. An electronic document management system according to claim 4 wherein a unique barcode for each page of said defined electronic document is generated by said barcode generator from said digest, said document and revision numbers and paging details for said defined electronic document and each said unique barcode is added to the specific page of said defined electronic document associated therewith, wherein the resulting barcoded defined electronic document is forwarded by said document forwarding component.

6. An electronic document management system according to claim 5 and further comprising a document image generator for generating an electronic image of said barcoded defined electronic document, wherein said document forwarding component forwards said electronic image.

7. An electronic document management system according to claim 6 wherein said received electronic document has been hand-signed and faxed by said user.

8. An electronic document management system according to claim 6 and further comprising a digital exchange key generator for generating a unique digital exchange key associated with said defined electronic document, said generated unique digital exchange key being generated by applying said secure algorithm to said electronic image, and forwarding said digital exchange key for storage.

9. An electronic document management system according to claim 8 wherein said electronic document received by said document receiving component comprises a digital signature and said system further comprises a digital signature authentication component for authenticating said digital signature and a digital exchange key verification component for determining the validity of said received electronic document, wherein said digital exchange key verification component determines a digital exchange key by applying said secure algorithm to said received electronic document and comparing said determined digital exchange key to said stored unique digital exchange key associated with said defined electronic document.

10. A method for managing and verifying the contents of an electronic document exchanged through a network and comprising variable data input by a user, said method comprising:
(a) capturing data defining an electronic document, whereby said data comprises at least said variable data, and forwarding said data for storage;
(b) generating a digest from said defined electronic document by applying a secure algorithm thereto whereby said digest is uniquely associated with said defined electronic document, and forwarding said digest for storage in association with said defined electronic document;
(c) generating a barcode from said generated digest whereby said barcode uniquely identifies said defined electronic document and the contents thereof;
(d) forwarding said defined electronic document with said barcode added thereto for use by a user;
(e) receiving from a user a signed electronic document comprising variable data and a barcode; and,
(f) determining the validity of said barcode of a document received by said document receiving component wherein a digest component of said barcode is compared to said stored digest associated with said defined electronic document.

11. A method according to claim 10 whereby said user inputs said variable data into a pre-determined electronic form template and said data defining said electronic document comprises said variable data and said pre-determined electronic form template.

12. A method according to claim 11 and further comprising generating a unique document number for said defined electronic document and forwarding said document number for storage with said captured data, whereby said digest is generated from said defined electronic document and said document number.

13. A method according to claim 12 and further comprising generating a unique document revision number for said defined electronic document and forwarding said document revision number for storage with said captured data, whereby said digest is generated from said defined electronic document and said document and revision numbers.

14. A method according to claim 13 and further comprising generating a unique barcode for each page of said defined electronic document from said digest, said document and revision numbers and paging details for said defined electronic document, adding each said unique barcode to the specific page of said defined electronic document which is associated therewith and forwarding the resulting barcoded defined electronic document for use by a user.

15. A method according to claim 14 and further comprising generating an electronic image of said barcoded defined electronic document and forwarding said image for use by a user.

16. A method according to claim 15 and further comprising generating a unique digital exchange key associated with said defined electronic document by applying said secure algorithm to said electronic image and forwarding said digital exchange key for storage.

17. A method according to claim 16 whereby said electronic document received by said document receiving component comprises a digital signature, said method further comprising:
(a) authenticating said digital signature; and,
(b) determining the validity of said received electronic document by applying said secure algorithm to said received electronic document and comparing the resulting determined digital exchange key to said stored unique digital exchange key associated with said defined electronic document.

18. A method according to claim 15 whereby said received electronic document has been hand-signed and faxed by said user.
